(19) United States
(12) Patent Application Publication
(10) Pub. No.: US 2011/0094690 A1
(43) Pub. Date: Apr. 28, 2011

(54) PARTITIONING DEVICE FOR PASSENGER COMPARTMENT OF A VEHICLE

(75) Inventor: Paul Lin, Tainan Hsien (TW)

(73) Assignee: MACAUTO INDUSTRIAL CO., LTD., Yung-Kang City (TW)

(21) Appl. No.: 12/755,984

(22) Filed: Apr. 7, 2010

(30) Foreign Application Priority Data
Oct. 28, 2009 (TW) 098136476

(51) Int. Cl. E06B 9/82

(52) U.S. Cl. 160/298

(57) ABSTRACT

A partitioning device includes a fixing unit, a locking mechanism, and an article blocking mechanism. The fixing unit includes a first fixing seat, and a second fixing seat spaced apart from the first fixing seat. The locking mechanism includes a rod seat, and a securing unit that is mounted on the first fixing seat. The article blocking mechanism includes a rod that is mounted rotatably to the second fixing seat on one end and fixedly to the rod seat on its other end, a curtain member that is fixed at one end to the rod and that may be wound around and unwound from the rod, and an anchoring unit that is connected to a free end of the curtain member and that is adapted to be releasably anchored at a location in the passenger compartment of the vehicle such that the curtain member is at an extending position.

### BACKGROUND OF THE INVENTION

1. Field of the Invention

The present invention relates to a partitioning device, more particularly to a partitioning device for a passenger compartment of a vehicle.

2. Description of the Related Art

A conventional partitioning device is mounted in a passenger compartment of a vehicle, and includes a curtain member. The curtain member is able to be wound or unwound so as to adjust its length, and when fully unwound, may be used for separating goods in the vehicle from the remainder of the passenger compartment. When the vehicle is a sports utility vehicle, a hatchback, or the like, in which the trunk space is spatially communicated with the passenger compartment, the curtain member may be used to partition such a trunk space from the passenger compartment.

However, a drawback of the conventional partitioning device is that when the vehicle abruptly brakes, the curtain member is not able to effectively prevent goods from rushing forward as the length of the curtain member cannot be fixed. Accordingly, the goods may hit the driver and/or passengers and thereby cause injury.

### SUMMARY OF THE INVENTION

Therefore, the object of the present invention is to provide a partitioning device for a passenger compartment of a vehicle, which can prevent goods from rushing forward in a vehicle and striking the driver and/or passengers to thereby improve safety.

Accordingly, a partitioning device of the present invention comprises a fixing unit, a locking mechanism, and an article blocking mechanism.

The fixing unit includes a first fixing seat, and a second fixing seat that is horizontally spaced apart from the first fixing seat.

The locking mechanism includes a rod seat, and a securing unit that is mounted on the first fixing seat and associated with the rod seat. The securing unit is operable to lock upon receiving an instantaneous inertial force resulting from when the vehicle abruptly brakes to thereby lock the rod seat.

The article blocking mechanism includes a rod that is mounted rotatably to the second fixing seat on one end and fixedly to the rod seat on its other end, a curtain member that is fixed at one end to the rod and that may be wound around and unwound from the rod, and an anchoring unit that is connected to a free end of the curtain member and that is adapted to be releasably anchored at a location in the passenger compartment of the vehicle such that the curtain member is at an extending position.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a partitioning device according to a preferred embodiment of the present invention;

FIG. 2 is a perspective view of the partitioning device of the preferred embodiment to illustrate the partitioning device mounted in a vehicle;

FIG. 3 is a front, partly sectional view of the partitioning device of the preferred embodiment;

FIG. 4 is an exploded perspective view of the partitioning device of the preferred embodiment to illustrate the relationship between a fixing unit and a locking mechanism;

FIG. 5 is a schematic side view of the partitioning device of the preferred embodiment to illustrate the locking mechanism at an unengaging position;

FIG. 6 is a schematic side view of the partitioning device of the preferred embodiment to illustrate the locking mechanism at an engaging position; and

FIG. 7 is a schematic side view of the partitioning device of the preferred embodiment to illustrate the locking mechanism being changed to the unengaging position from the engaging position.

### DETAILED DESCRIPTION OF THE PREFERRED EMBODIMENT

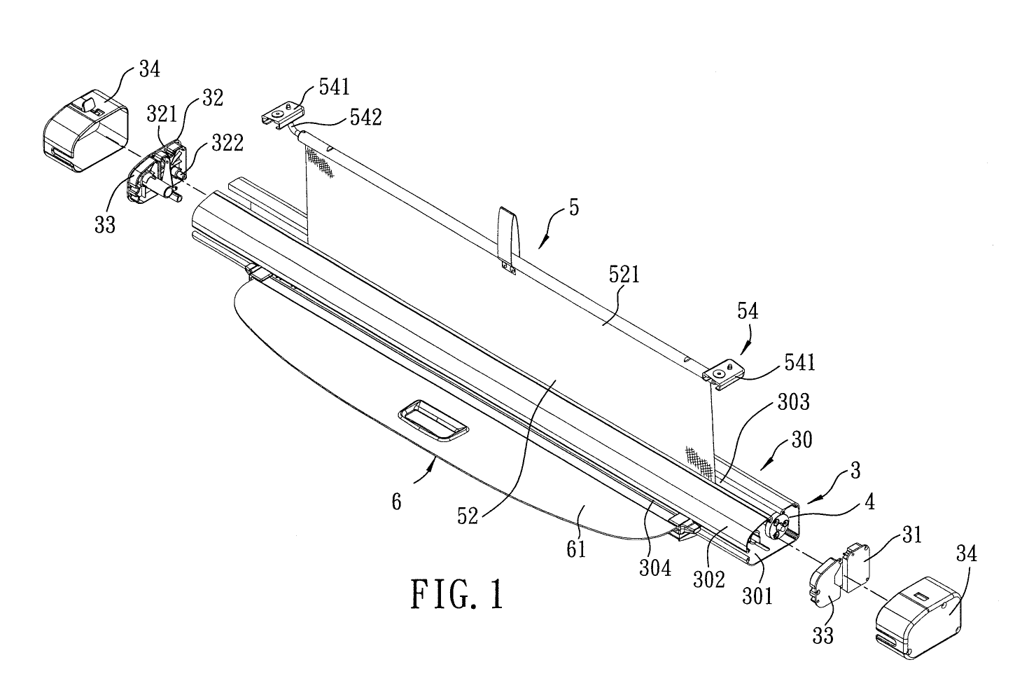

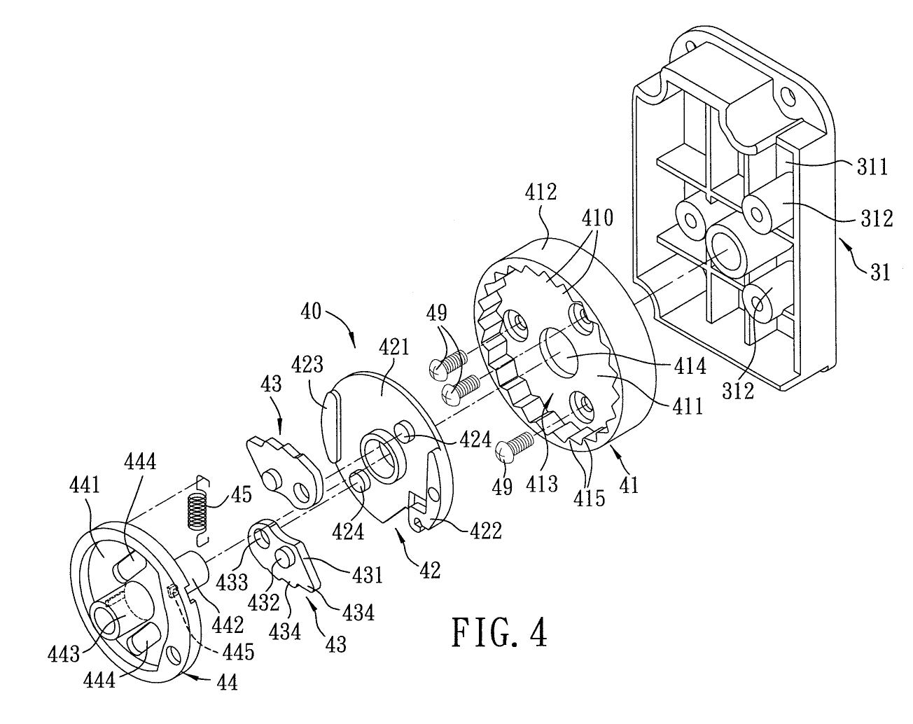

Referring to FIGS. 1 to 4, a preferred embodiment of a partitioning device of the present invention is used for a passenger compartment of a vehicle. In some embodiments, the partitioning device is mounted in a storage space 2 of the passenger compartment of a vehicle. For example, in a sports utility vehicle, a hatchback, etc., a storage space 2 that is spatially communicated with the remainder of the passenger compartment is provided behind the rear seats, in which case the partitioning device of the present invention is disposed directly within this storage space 2. In other embodiments, the partitioning device of the present invention is disposed in the area of the back seats directly behind the driver seat and front passenger seat. The portioning device of the present invention may be disposed in other areas of the passenger compartment and is not limited to these examples.

The partitioning device of the present invention includes a fixing unit 3, a locking mechanism 4, an article blocking mechanism 5, and a sheltering unit 6.

The fixing unit 3 includes a first fixing seat 31, a second fixing seat 32, a protection cover 30, two mounting seats 33, and two decorative covers 34. The second fixing seat 32 is horizontally spaced apart from the first fixing seat 31. The protection cover 30 extends horizontally, has two end portions, and is mounted between the first fixing seat 31 and the second fixing seat 32. The mounting seats 33 are horizontally spaced apart from each other. The protection cover 30 has an enclosing wall 302 defining an accommodating space 301. The enclosing wall 302 has an extending slot 303 facing upwardly and a sheltering unit slot 304 facing rearwardly.

The first fixing seat 31 and the second fixing seat 32 are mounted respectively on two end portions of the enclosing wall 302. The first fixing seat 31 has a first wall 311, and a plurality of fixing pillars 312 that extend from the first wall 311. The second fixing seat 32 includes a second wall 321, and a first mounting component 322 that extends from the second wall 321. The mounting seats 33 are also mounted respectively on the two end portions of the enclosing wall 302, and are disposed respectively behind the first fixing seat 31 and the second fixing seat 32. The decorative covers 34 are sleeved respectively on outer peripheries of the two end portions of the enclosing wall 302. One decorative cover 34 covers the first fixing seat 31 and the corresponding mounting seat 33, and the other decorative cover 34 covers the second fixing seat 32 and the corresponding mounting seat 33.

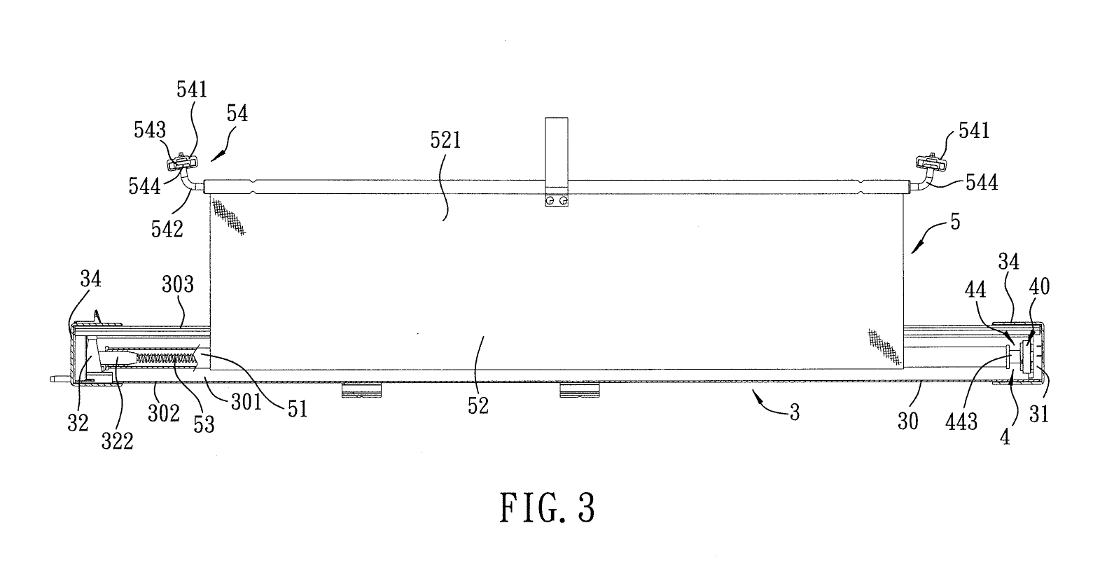

Referring to FIGS. 3, 4, and 5, the locking mechanism 4 includes a rod seat 44, and a securing unit 40 that is mounted on the first fixing seat 31 and associated with the rod seat 44. The securing unit 40 is operable to lock upon receiving an instantaneous inertial force resulting from when the vehicle abruptly brakes to thereby lock the rod seat 44.

The securing unit 40 includes an engaging seat 41, a pivoting seat 42, and two catch components 43. The engaging seat 41 is mounted fixedly to the first fixing seat 31 by using a plurality of fixing components 49 extending into the fixing pillars 312 of the first fixing seat 31. Each of the catch components 43 is mounted pivotally on the pivoting seat 42 and includes at least one catch tooth 434.

The engaging seat 41 includes an engaging bottom wall 411, a surrounding wall 412, and a receiving space 413. The surrounding wall 412 surrounds the engaging bottom wall 411. The receiving space 413 is defined by the engaging bottom wall 411 and the surrounding wall 412. The engaging bottom wall 411 has a connecting hole 414. The surrounding wall 412 includes a plurality of inclined gear teeth 415 that surround and protrude toward a center of the receiving space 413. Each adjacent pair of the gear teeth 415 defines a groove 410 therebetween for receiving the catch tooth 434 of each of the catch components 43. Each of the gear teeth 415 has an engaging face 416 and an inclined surface 417.

The pivoting seat 42 is mounted rotatably in the receiving space 413 of the engaging seat 41, and includes a circular pivoting bottom wall 421, a first clamp 422, a balancing piece 423, and two pivoting supports 424. The first clamp 422 extends from the bottom wall 421 and is disposed on an edge of the bottom wall 421. The balancing piece 423 extends from the bottom wall 421 on a side of the pivoting seat 42 opposite to the first clamp 422. The pivoting supports 424 extend from the bottom wall 421 on sides of the pivoting seat 42 opposite to each other.

The catch components 43 are respectively mounted pivotally on the pivoting supports 424 of the pivoting seat 42. Each of the catch components 43 further includes a body 431 that is formed with the catch tooth 434, has a first insertion pillar 432 that extends from the body 431, and is further formed with a hole 433 that is spaced apart from the first insertion pillar 432. The catch tooth 434 faces toward the surrounding wall 412 of the engaging seat 41. The hole 433 is for insertion of the pivoting support 424 thereinto.

The rod seat 44 includes a circular seat bottom wall 441, a second insertion pillar 442, and a second mounting component 443. The seat bottom wall 441 is formed with two slots 444. The slots 444 are respectively for extension of the first insertion pillars 432 thereinto.

The second insertion pillar 442 extends substantially from a center of the seat bottom wall 441, through the pivoting seat 42, and into the connecting hole 414. The second mounting component 443 is disposed on the center of the seat bottom wall 441 and opposes the first mounting component 322 of the second fixing seat 32. The rod seat 44 further includes a second clamp 445.

The securing unit 40 further includes an elastic component 45. The elastic component 45 is connected to the first clamp 422 and the second clamp 445 to thereby interconnect the pivoting seat 42 and the rod seat 44 elastically.

Referring to FIGS. 1, 2, and 3, the article blocking mechanism 5 is mounted in the accommodating space 301, and includes a rod 51, a curtain member 52, an anchoring unit 54, and a winding unit 53. The rod 51 is mounted rotatably to the second fixing seat 32 on one end and fixedly to the rod seat 44 on its other end. That is, the rod 51 is disposed rotatably on the first mounting component 322 and fixedly to the second mounting component 443.

The curtain member 52 is fixed at one end to the rod 51, and may be wound around and unwound from the rod 51. The anchoring unit 54 is connected to a free end 521 of the curtain member 52, and is adapted to be releasably anchored at a location in the passenger compartment of the vehicle such that the curtain member 52 is placed in and maintained at an extending position.

The winding unit 53 is for providing a winding force to the rod 51. The manner in which the automatic winding function of the curtain member 52 is realized is well-known and so a detailed description thereof will be omitted herein.

The rod 51 is mounted rotatably to the first mounting component 322, and is inserted fixedly into the second mounting component 443 of the rod seat 44. The free end 521 of the curtain member 52 is able to extend from the extending slot 303 of the enclosing wall 302. The anchoring unit 54 includes two fastener tabs 541 each of which has a mounting groove 543, and a hanging rod 542. The fastener tabs 541 are adapted to be fixed at predetermined locations in the passenger compartment of the vehicle whereat the anchoring unit 54 is releasably anchored.

The hanging rod 542 is mounted to the free end 521 of the curtain member 52, and is releasably engaged with the fastener tabs 541 when the curtain member 52 is at the extending position. The hanging rod 542 includes two clamping portions 544. The clamping portions 544 engage the mounting grooves 543 of the fastener tabs 541, respectively.

The sheltering unit 6 is mounted between the mounting seats 33, and is able to extend from the fixing unit 3. The sheltering unit 6 includes a sheltering member 61. The sheltering member 61 is able to extend rearwardly from the sheltering unit slot 304 of the enclosing wall 302 for covering an article in the storage space 2. As an example, the sheltering unit 6 may be used to prevent shaking of the article. In some embodiments, the sheltering unit 6 may be omitted from the configuration of the present invention.

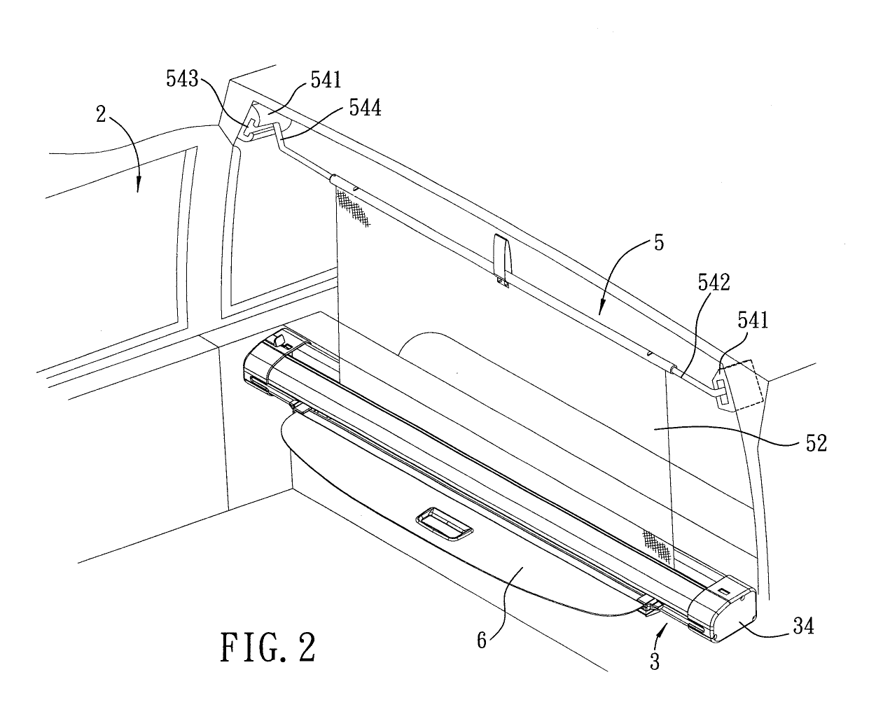

Referring to FIGS. 2, 3, and 5, when the partitioning device is used, the clamping portions 544 engage the mounting grooves 543 of the fastener tabs 541, respectively, such that the curtain member 52 can overcome the winding force from the winding unit 53 and extend from the extending slot 303 for separating the storage space 2 from the remainder of the passenger compartment. In a normal condition, the catch components 43 of the locking mechanism 4 are inwardly positioned, and in this state, the catch components 43 do not engage the engaging seat 41.

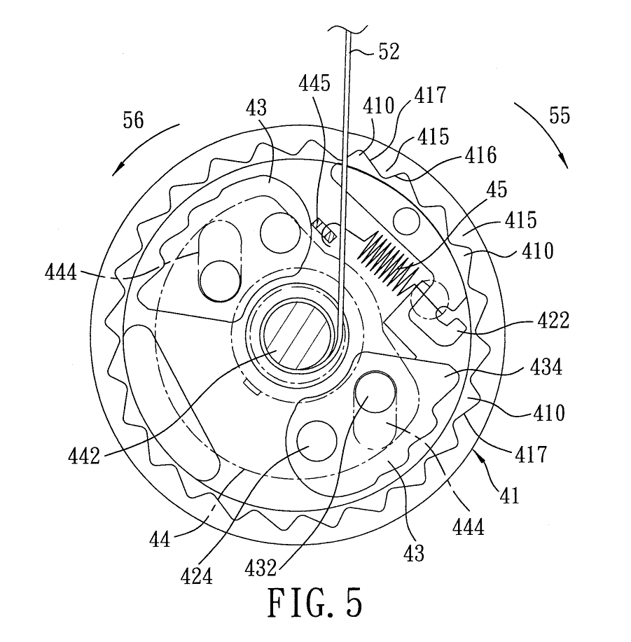

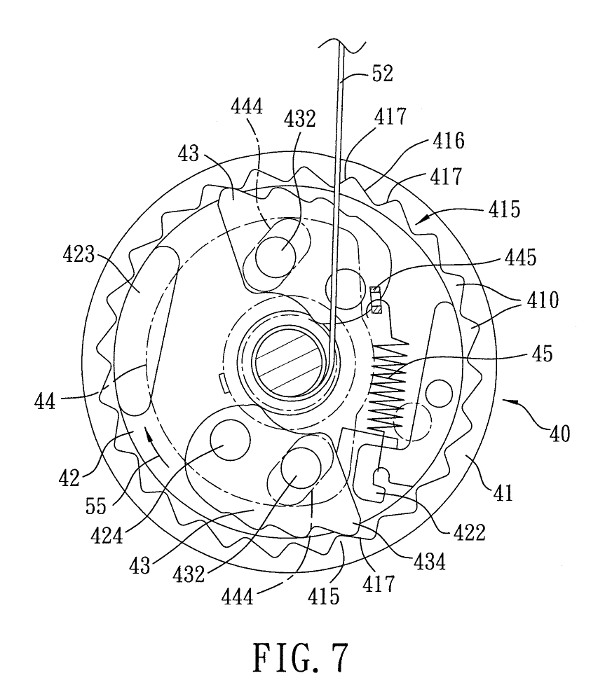

By separating the clamping portions 544 from the mounting grooves 543, the curtain member 52 can be wound around the rod 51, and changed to a wound position. During this winding process, the rod 51 associated with the rod seat 44 can rotate along a winding direction 55 (see FIGS. 5 and 7), and the connection of the elastic component 45 can make the rod seat 44, the pivoting seat 42, and the catch components 43 rotate synchronously. Also during this process, the catch teeth 434 of the catch components 43 rotate along the winding direction 55, and their movement corresponds to the inclined surfaces 417. Therefore, the curtain member 52 can be wound as the catch components 43 do not engage the engaging seat 41.

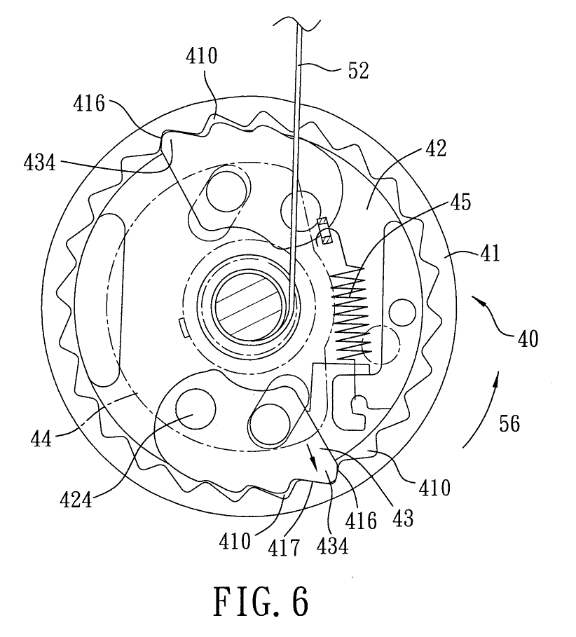

By extending the curtain member 52, the curtain member 52 rotates along an unwinding direction 56 (see FIGS. 5 and 6), and changes to the extending position from the wound position. During this unwinding process, the curtain member 52 rotates the rod 51, and the rod seat 44 also rotates as the rod 51 rotates. Furthermore, the rod seat 44 rotates the pivoting seat 42 and the catch components 43 using the elastic component 45 until the clamping portions 544 of the hanging rod 542 clamp the mounting grooves 543 of the fastener tabs 541 respectively.

Referring to FIGS. 2, 5, and 6, in the normal state, the rod 51 can rotate along the winding or unwinding direction. However, when the vehicle abruptly brakes, the instantaneous inertial force acts upon the securing unit 40, such that the catch component 43 swings toward the surrounding wall 412 along the slot 444 and locks against the engaging face 416 of one of the gear teeth 415 so as to lock the rod seat 44. Therefore, the extending length of the curtain member 52 can be fixed, and when the curtain member 52 is at the extending position, the goods in the storage space 2 are prevented from rushing forward and striking the passengers and/or driver.

Referring to FIGS. 6 and 7, after such abrupt braking, the rod seat 44 can rotate along the winding direction 55 by pressing the curtain member 52 down. As the gear teeth 415 can be moved away from the inclined surfaces 417, the rod seat 44 can rotate freely along the winding direction 55. Consequently, the curtain member 52 can be wound or unwound freely.

The locking mechanism 4 of the present invention has an automatic locking function to fix the extending length of the curtain member 52 when the vehicle abruptly brakes. Therefore, the present invention can improve safety and prevent goods from rushing forward in a vehicle and striking passengers or the driver.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A partitioning device for a passenger compartment of a vehicle, comprising:
a fixing unit including a first fixing seat, and a second fixing seat that is horizontally spaced apart from said first fixing seat;
a locking mechanism including a rod seat, and a securing unit that is mounted on said first fixing seat and associated with said rod seat, said securing unit being operable to lock upon receiving an instantaneous inertial force resulting from when the vehicle abruptly brakes to thereby lock said rod seat; and
an article blocking mechanism including a rod that is mounted rotatably to said second fixing seat on one end and fixedly to said rod seat on its other end, a curtain member that is fixed at one end to said rod and that may be wound around and unwound from said rod, and an anchoring unit that is connected to a free end of said curtain member and that is adapted to be releasably anchored at a location in the passenger compartment of the vehicle such that said curtain member is placed in and maintained at an extending position.

2. The partitioning device as claimed in claim 1, wherein:
said securing unit includes an engaging seat that is mounted fixedly to said first fixing seat and that has a surrounding wall and a receiving space defined by said surrounding wall, a pivoting seat that is mounted rotatably in said receiving space of said engaging seat, and a catch component that is mounted pivotally on said pivoting seat and includes at least one catch tooth;
said surrounding wall includes a plurality of inclined gear teeth that surround and protrude toward a center of said receiving space, each adjacent pair of said gear teeth defining a groove therebetween for receiving said catch tooth, each of said gear teeth having an engaging face and an inclined surface; and
when said curtain member is at the extending position and the instantaneous inertial force is acted upon said securing unit, said catch component swings toward said surrounding wall and locks against said engaging face of one of said gear teeth so as to lock said rod seat.

3. The partitioning device as claimed in claim 2, wherein said pivoting seat includes a pivoting bottom wall and a first clamp that is disposed on said bottom wall, said rod seat includes a second clamp, and said securing unit further includes an elastic component that is connected to said first clamp and said second clamp to thereby interconnect said pivoting seat and said rod seat elastically.

4. The partitioning device as claimed in claim 3, wherein:
said rod seat further includes a seat bottom wall formed with a slot;
said catch component further includes a body that is formed with said catch tooth, has a first insertion pillar that extends from said body and into said slot of said rod seat, and is further formed with a hole spaced apart from said first insertion pillar; and
said pivoting seat further includes a pivoting support that extends from said bottom wall and into said hole of said catch component.

5. The partitioning device as claimed in claim 4, wherein said engaging seat further includes an engaging bottom wall that has a connecting hole, and said rod seat further includes a second insertion pillar that extends substantially from a center of said seat bottom wall and into said connecting hole.

6. The partitioning device as claimed in claim 1, wherein said second fixing seat includes a first mounting component, and said rod seat includes a second mounting component, said rod being mounted rotatably to said first mounting component and fixedly to said second mounting component.

7. The partitioning device as claimed in claim 6, wherein said rod is inserted fixedly into said second mounting component of said rod seat.

8. The partitioning device as claimed in claim 1, wherein:
said fixing unit further includes a protection cover that is mounted between said first fixing seat and said second fixing seat and that has an enclosing wall defining an accommodating space, said enclosing wall having an extending slot; and
said article blocking mechanism is mounted in said accommodating space, and further includes a winding unit for providing a winding force to said rod, said free end of said curtain member extending from said extending slot, said anchoring unit including at least one fastener tab that is adapted to be fixed to the location in the passenger compartment of the vehicle whereat said anchoring unit is releasably anchored, and a hanging rod that is mounted to said free end of said curtain member and is releasably engaged with said fastener tab when said curtain member is at the extending position.
